(19) United States
(12) Patent Application Publication
(10) Pub. No.: US 2008/0030645 A1
(43) Pub. Date: Feb. 7, 2008

(54) LIGHT EMITTING UNIT, BACKLIGHT ASSEMBLY, AND DISPLAY APPARATUS HAVING THE SAME

(75) Inventors: Young-Joo NAM, Daegu=city (KR); Dong-Gyun RA, Asan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/832,888

(22) Filed: Aug. 2, 2007

(30) Foreign Application Priority Data
Aug. 3, 2006 (KR) 2006-73454

(51) Int. Cl. G02F 1/13357; F21S 4/00; F21V 23/00; F21V 8/00

(52) U.S. Cl. 349/61; 315/291; 315/35; 315/36; 362/235; 362/249; 362/382; 362/613

(57) ABSTRACT

A light emitting unit includes a power supply line that supplies a power supply voltage to a light source part and a ground member that grounds the light source part, and the power supply line is disposed on a different layer from that of the ground member. The light emitting unit of the present invention may be included in a backlight assembly which may be included in a display assembly.

### CROSS-REFERENCE TO RELATED APPLICATION

This application claims priority from and the benefit of Korean Patent Application No. 2006-73454, filed on Aug. 3, 2006, which is hereby incorporated by reference for all purposes as if fully set forth herein.

### BACKGROUND OF THE INVENTION

1. Field of the Invention

The present invention relates to a light emitting unit, a backlight assembly, and a display apparatus. More particularly, the present invention relates to a light emitting unit having a reduced size, and a backlight assembly and a display apparatus including the light emitting unit.

2. Discussion of the Background

In general, display apparatuses convert data processed by an information processing device into an image. A liquid crystal display, which is one type of display apparatus, displays images by using the electrical and optical properties of liquid crystals. Liquid crystal displays may be small and lightweight, have low power consumption, and are widely applied to various electronic instruments.

A conventional liquid crystal display includes a liquid crystal display panel displaying an image and a backlight assembly supplying light to the liquid crystal display panel. The liquid crystal display panel includes two substrates and a liquid crystal layer interposed between the two substrates.

In the conventional liquid crystal display, the backlight assembly mainly employs lamp emitting a white light, such as a cold cathode fluorescent lamp or a flat fluorescent lamp, as the light source thereof. Recently, however, in order to reduce power consumption and improve color reproducibility, a backlight assembly employing light emitting diodes has been developed.

In general, the light emitting diodes are mounted on a flexible printed circuit board and positioned adjacent to a side face of a light guide plate. Power supply lines supplying a power supply voltage to the light emitting diodes and ground lines grounding the light emitting diodes are formed on the flexible printed circuit board with the light emitting diodes. In order to obtain space for the power supply lines and the ground lines, the size of the flexible printed circuit board increases as the number of power supply lines and ground lines increases. Since the flexible printed circuit board is positioned to correspond to a non-effective display area, for example, a bezel area, of the liquid crystal display, the flexible printed circuit board limits the size of the liquid crystal display.

### SUMMARY OF THE INVENTION

The present invention provides a light emitting unit having a reduced size.

The present invention also provides a backlight assembly including the above light emitting unit.

The present invention also provides a display apparatus including the above backlight assembly.

Additional features of the invention will be set forth in the description which follows, and in part will be apparent from the description, or may be learned by practice of the invention.

The present invention discloses a light emitting unit including an insulation member, a light source part, a power supply line, and a ground member.

The light source part is mounted on the insulation member and receives a power supply voltage to generate a light. The power supply line is disposed on the insulation member and connected to the light source part to provide the power supply voltage to the light source part. The ground member is disposed below the insulation member and connected to the light source part to ground the light source part.

The present invention also discloses a backlight assembly including a light guide plate and a light emitting unit. The light guide plate changes the path of light from the light emitting unit. The light emitting unit includes an insulation member, a light source part, a power supply line, and a ground member. The light source part is mounted on the insulation member and positioned adjacent to a side face of the light guide plate to receive a power supply voltage and generate a light. The power supply line is disposed on the insulation member and connected to the light source part and provides the power supply voltage to the light source part. The ground member is disposed below the insulation member and connected to the light source part and grounds the light source part.

The present invention also discloses a backlight assembly including a light emitting unit and an optical sheet. The light emitting unit includes an insulation member, a light source part, a power supply line, and a ground member. The light source part is mounted on the insulation member and receives a power supply voltage to generate a light. The power supply line is disposed on the insulation member and connected to the light source part and provides the power supply voltage to the light source part. The ground member is disposed below the insulation member and connected to the light source part to ground the light source part. The optical sheet is disposed on the light emitting unit to enhance optical properties of the light.

The present invention also discloses a display apparatus including a display panel assembly and a light emitting unit. The display panel assembly includes a display panel that displays an image corresponding to an image signal using a light and a driving circuit part that applies the image signal to the display panel. The light emitting unit is disposed under the display panel to supply the light to the display panel. The light emitting unit includes an insulation member, a light source part, a power supply line, and a ground member. The light source part is mounted on the insulation member and receives a power supply voltage to generate a light. The power supply line is formed on the insulation member and connected to the light source part to provide the power supply voltage to the light source part. The ground member is disposed below the insulation member and connected to the light source part to ground the light source part.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a light emitting unit according to an exemplary embodiment of the present invention.

FIG. 2 is a plan view showing the light emitting unit of FIG. 1.

FIG. 3 is a plan view showing the first light source parts of FIG. 2.

FIG. 4 is a cross-sectional view taken along line I-I′ of FIG. 3.

FIG. 5 is a block diagram showing a connection between the compensator and light sources of FIG. 2.

FIG. 6 is an exploded perspective view showing a light emitting unit according to another exemplary embodiment of the present invention.

FIG. 7 is a plan view showing the light emitting unit of FIG. 6.

FIG. 8 is a cross-sectional view showing the first light source part of FIG. 7.

FIG. 9 is a plan view showing a light emitting unit according to another exemplary embodiment of the present invention.

FIG. 10 is a cross-sectional view showing the light emitting unit of FIG. 9.

FIG. 11 is an exploded perspective view showing a liquid crystal display according to an exemplary embodiment of the present invention.

FIG. 12 is a cross-sectional view taken along line II-II′ of FIG. 11.

FIG. 13 is a cross-sectional view showing a liquid crystal display according to another exemplary embodiment of the present invention.

FIG. 14 is a plan view showing the lower face of the liquid crystal display of FIG. 13.

FIG. 15 is an exploded perspective view showing a liquid crystal display according to another exemplary embodiment of the present invention.

FIG. 16 is a cross-sectional view taken along line III-III′ of FIG. 15.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

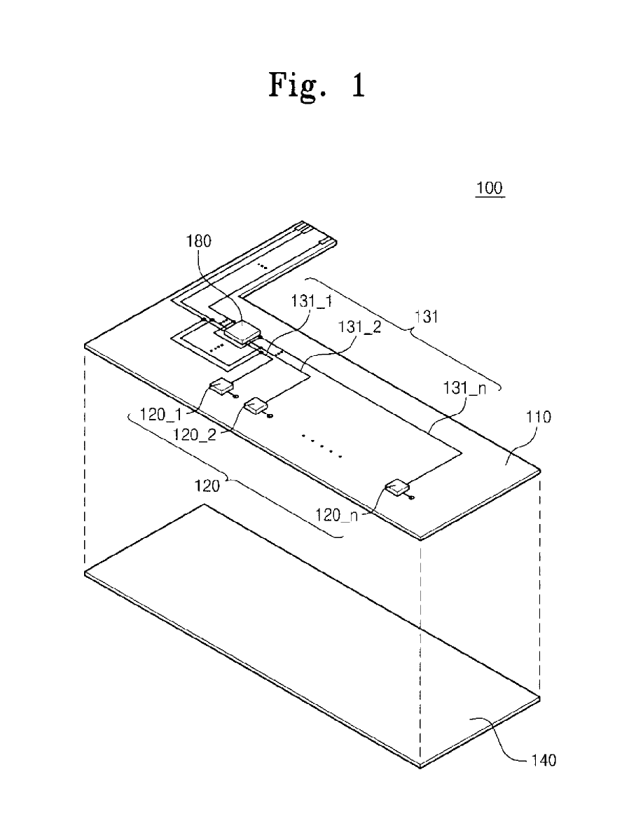

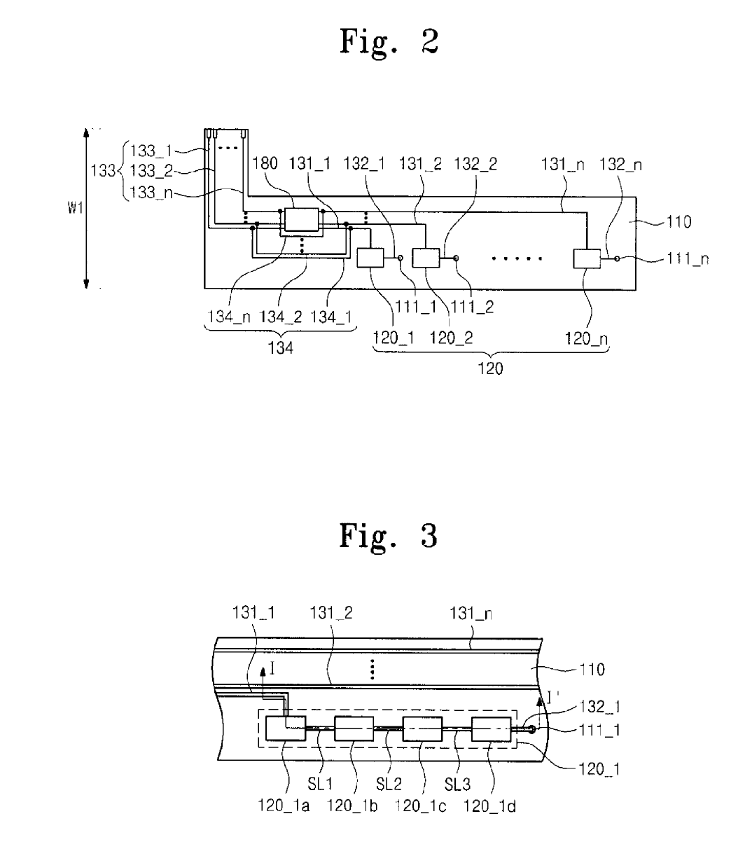

FIG. 1 is an exploded perspective view showing a light emitting unit according to an exemplary embodiment of the present invention, and FIG. 2 is a plan view showing the light emitting unit of FIG. 1.

Referring to FIG. 1 and FIG. 2, a light emitting unit 100 includes a base film 110, a plurality of light source parts 120, a plurality of power supply lines 131 connected to the light source parts 120, and a grounding member 140.

The base film 110 includes an insulation material, for example, polyimide.

The light source parts 120 are mounted on the base film 110. The light source parts 120 receive a power supply voltage from an external device to emit light. The light source parts 120 include first to n-th light source parts 120-1, 120-2, . . . , 120-n and are spaced apart from each other. In the exemplary embodiment, n is a natural number that is equal to or more than 1.

In the exemplary embodiment, the first to n-th light source parts 120-1, 120-2, . . . , 120-n have the same configuration and function, and thus, the first light source part 120-1 will be described in detail as a representative example.

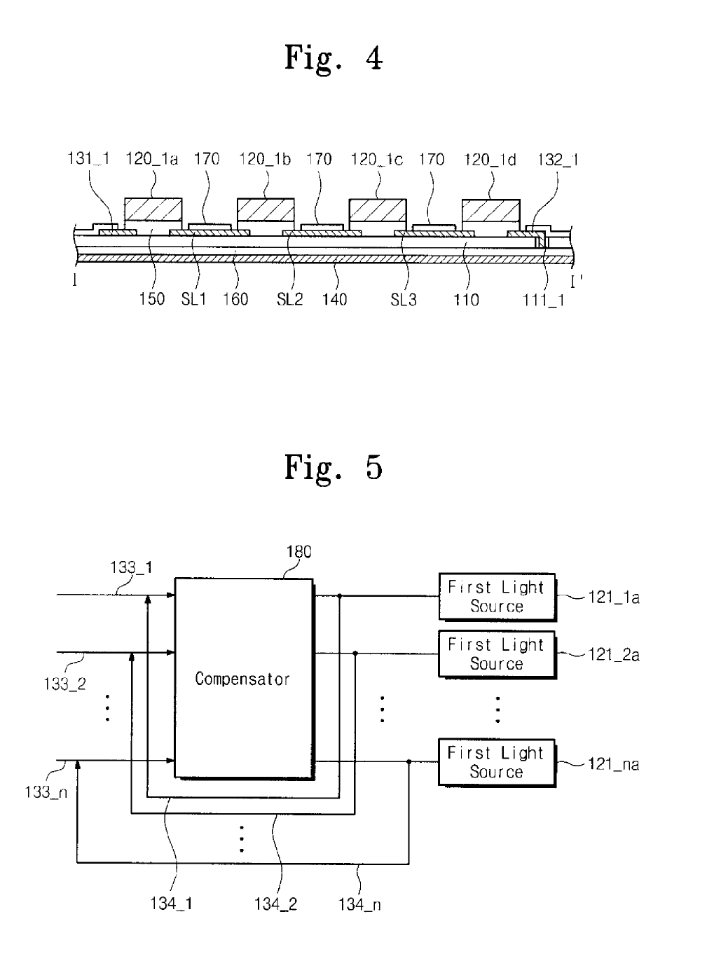

FIG. 3 is a plan view showing a first light source part of FIG. 2, and FIG. 4 is a cross-sectional view taken along line I-I′ of FIG. 3.

Referring to FIG. 3 and FIG. 4, the first light source part 120-1 includes first, second, third, and fourth light sources 120-1a, 120-1b, 120-1c, and 120-1d. Although four light sources have been shown in FIG. 3, the number of light sources may be increased or decreased as needed.

Particularly, the first, second, third, and fourth light sources 120-1a, 120-1b, 120-1c, and 120-1d include a light emitting diode and are arranged linearly and spaced apart from each other. The first, second, third, and fourth light sources 120-1a, 120-1b, 120-1c, and 120-1d are connected to each other in series by means of first, second, and third sub-connection lines SL1, SL2, and SL3 and mounted on the base film 110 using a conductive member 150. The conductive member 150 includes an anisotropic conductive film (ACF) or a soldering member. The soldering member may attach the first light source 120-1a to the base film 110 through a soldering process using heat and pressure.

Referring to FIG. 2 and FIG. 3, the power supply lines 131 include first to n-th power supply lines 131-1, 131-2, . . . , 131-n. The number of the power supply lines 131 is equal to the number of light source parts 120.

The first to n-th power supply lines 131-1, 131-2, . . . , 131-n are connected to the first to n-th light source parts 120-1, 120-2, . . . , 120-n, respectively, and provide a power supply voltage from an exterior source to the first to n-th light source parts 120-1, 120-2, . . . , 120-n.

In the present embodiment, the connection structures between the first to n-th power supply lines 131-1, 131-2, . . . , 131-n and the first to n-th light source parts 120-1, 120-2, . . . , 120-n are the same. Therefore, the connection structure between the first light source part 120-1 and the first power supply line 131-1 will be described in detail as a representative example.

Particularly, the first power supply line 131-1 is connected to the first light source 120-1a of the first light source part 120-1, and the second, third, and fourth light sources 120-1b, 120-1c, and 120-1d of the first light source part 120-1 receive the power supply voltage through the first, second, and third sub-connection lines SL1, SL2, and SL3, respectively.

Similarly, the second to n-th power supply lines 131-2, . . . , 131-n are connected to the corresponding first light sources of the second to n-th light source parts 120-2, . . . , 120-n.

The ground member 140 is disposed below the base film 110. The ground member 140 includes a flexible metal material and is connected to the light source parts 120 to ground the light source parts 120. As an example of the present invention, the ground member 140 may have a substantially rectangular shape and cover a lower face of the base film 110. However, the ground member 140 may partially cover the lower face of the base film 110 and have a narrow, stripe shape.

As described above, since the ground member 140 is disposed below the base film 110, the base film 110 may have a narrower width W1 than a conventional base film on which the ground lines are formed on an upper face of the base film. Further, the ground member 140 may cover the lower face of the base film 110, so that heat generated from the light emitting unit 100 may be rapidly discharged.

The light emitting unit 100 further includes an adhesive member to attach the ground member 140 to the base film 110. The adhesive member 160 is interposed between the base film 110 and the ground member 140 and includes a conductive material as the ACF.

The light emitting unit 100 further includes first to n-th connection lines 132-1, 132-2, . . . , 132-n that connect the ground member 140 and the light source parts 120.

The first to n-th connection lines 132-1, 132-2, . . . , 132-n are connected to the first to n-th light source parts 120-1, 120-2, . . . , 120-n, respectively.

Referring to FIG. 2 and FIG. 4, the first connection line 132-1 is connected to the fourth light source 120-1d of the first light source part 120-1. Similarly, the second to n-th connection lines 132-2, . . . , 132-n are connected to fourth light sources of the second to n-th light source parts 120-2, . . . , 120-n, respectively.

The base film 110 is provided with first to n-th via holes 111-1, 111-2, . . . , 111-n through which the adhesive member 160 is partially exposed. The first to n-th connection lines 132-1, 132-2, . . . , 132-n are connected to the adhesive member 160 through the first to n-th via holes 111-1, 111-2, . . . , 111-n, respectively, thereby connecting the first to n-th light source parts 120-1, 120-2, . . . , 120-n to the ground member 140.

The base film 110 further includes a protective member 170 formed thereon. The protective member 170 covers the upper face of the base film 110 to protect the first to n-th power supply lines 131-1, 131-2, . . . , 131-n and the first to n-th connection lines 132-1, 132-2, . . . , 132-n. The protective member 170 is partially removed from the base film 110 to expose pads of the first to n-th power supply lines 131-1, 131-2, . . . , 131-n and the first to n-th connection lines 132-1, 132-2, . . . , 132-n.

The light emitting unit 100 further includes a compensator 180 to control the power supply voltage for the light sources of the first to n-th light source parts 120-1, 120-2, . . . , 120-n. The compensator 180 is connected to the first to n-th power supply lines 131-1, 131-2, . . . , 131-n and to external lines 133 that transmit the power supply voltage from the external device to the compensator 180. The external lines 133 are formed on the base film 110 and include first to n-th external lines 133-1, 133-2, . . . , 133-n.

The first to n-th external lines 133-1, 133-2, . . . , 133-n are connected to the first to n-th power supply lines 131-1, 131-2, . . . , 131-n through a plurality of feedback lines 134. The feedback lines 134 include first to n-th feedback lines 134-1, 134-2, . . . , 134-n, and the first to n-th feedback lines 134-1, 134-2, . . . , 134-n are connected to the first to n-th power supply lines 131-1, 131-2, . . . , 132-n, respectively.

Hereinafter, a control method for currents of the light sources 120 using the compensator 180 will be described.

FIG. 5 is a block diagram showing a connection between the compensator and the light sources of FIG. 2.

Referring to FIG. 2 and FIG. 5, the first to n-th feedback lines 134-1, 134-2, . . . , 134-n are connected to the first to n-th power supply lines 131-1, 131-2, . . . , 131-n, respectively, to receive currents inputted to first light sources 120-1a, 120-2a, . . . , 120-na of the first to n-th light source parts 120-1, 120-2, . . . , 120-n, respectively. The currents for the first light sources 120-1a, 120-2a, . . . , 120-na are fed back to the compensator 180 through the first to n-th feedback lines 134-1, 134-2, . . . , 134-n and the first to n-th external lines 133-1, 133-2, . . . , 133-n, so that the compensator 180 controls the currents of the first to n-th light source parts 120-1, 120-2, . . . , 120-n and provides the first to n-th power supply lines 131-1, 131-2, . . . , 131-n with the controlled currents.

As described above, the compensator 180 is connected to the first to n-th power supply lines 131-1, 131-2, . . . , 131-n, and the currents input to the first to n-th light source parts 120-1, 120-2, . . . , 120-n are fed back to the compensator 180. Thus, the compensator 180 may control the currents of the first to n-th light source parts 120-1, 120-2, . . . , 120-n using the currents input to the first to n-th light source parts 120-1, 120-2, . . . , 120-n.

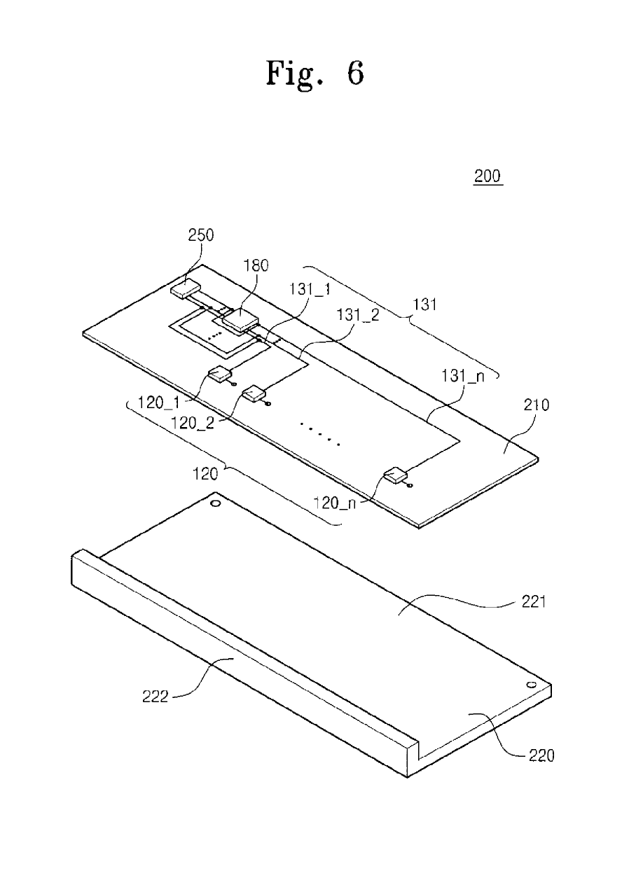

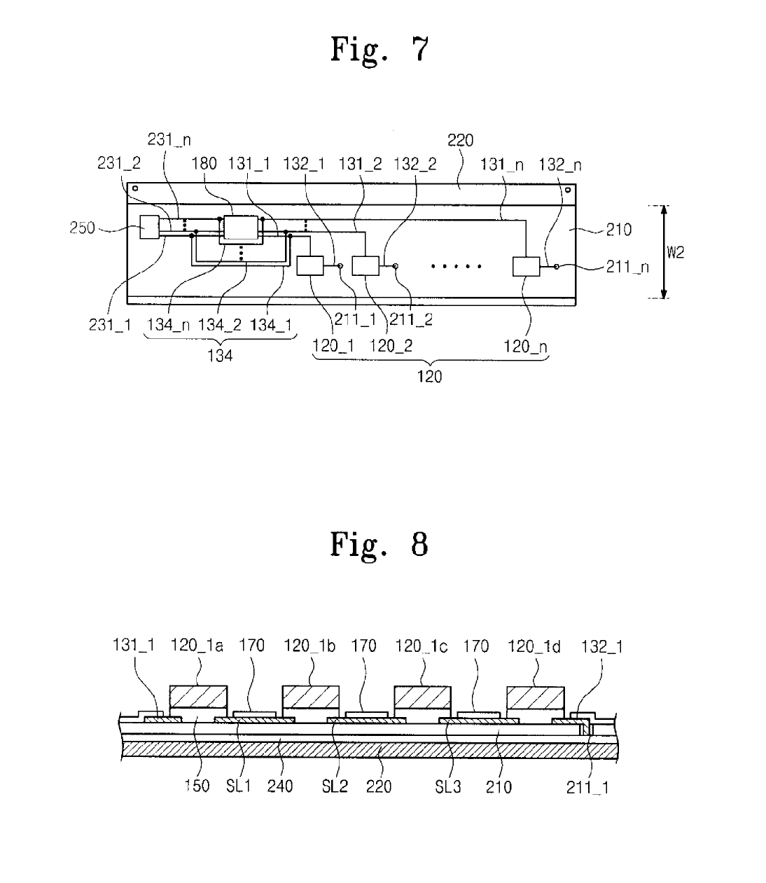

FIG. 6 is an exploded perspective view showing a light emitting unit according to another exemplary embodiment of the present invention, and FIG. 7 is a plan view showing the light emitting unit of FIG. 6. In FIG. 6 and FIG. 7, the light emitting unit has same configuration as that of the light emitting unit of FIG. 1 except for the insulation member 210 and the ground member 220. Therefore, in FIG. 6, the same reference numerals denote the same elements in FIG. 1, and thus, the detailed descriptions of the same elements will be omitted.

Referring to FIG. 6 and FIG. 7, the light emitting unit 200 includes an insulation member 210, a ground member 220, a plurality of light source parts 120, and a plurality of power supply lines 131.

The insulation member 210 includes an insulation material, for example, polyimide, and is formed on the ground member 220. The insulation member 210 may include an insulation film material or may be formed on the ground member 220 by coating an insulation material on the ground member 220.

The light source parts 120 are mounted on the insulation member 210 and receive a power supply voltage to emit light. The light source parts 120 include first to n-th light source parts 120-1, 120-2, . . . , 120-n that are spaced apart from each other. In the exemplary embodiment, n is a natural number equal to or more than 1.

The first to n-th light source parts 120-1, 120-2, . . . , 120-n have the same configuration, and thus, the first light source part 120-1 will be described as a representative example.

FIG. 8 is a cross-sectional view showing the first light source part of FIG. 7.

Referring to FIG. 7 and FIG. 8, the first light source part 120-1 includes first, second, third, and fourth light sources 120-1a, 120-1b, 120-1c, and 120-1d connected to each other in series. Although four light sources have been shown in FIG. 8, the number of light sources may be increased or decreased as needed.

The first to n-th light sources 120-1a, 120-1b, 120-1c, and 120-1d are connected to each other in series by first, second, and third sub-connection lines SL1, SL2, and SL3 and are mounted on the insulation member 210 by a conductive member 150.

The power supply lines 131 include first to n-th power supply lines 131-1, 131-2, . . . , 131-n. The first to n-th power supply lines 131-1, 131-2, . . . , 131-n are connected to the first to n-th light source parts 120-1, 120-2, . . . , 120-n and provide the first to n-th light source parts 120-1, 120-2, . . . , 120-n with the power supply voltage.

Particularly, the first power supply line 131-1 is connected to the first light source 120-1a of the first light source part 120-1, and the second, third, and fourth light sources 120-1b, 120-1c, and 120-1d of the first light source part 120-1 receive the power supply voltage through the first, second, and third sub-connection lines SL1, SL2, and SL3, respectively.

Similarly, the second to n-th power supply lines 131-2, . . . , 131-n are connected to the corresponding first light sources of the second to n-th light source parts 120-2, . . . , 120-n.

The ground member 220 includes a hard metal material to ground the first to n-th light source parts 120-1, 120-2, . . . , 120-n.

Particularly, the ground member 220 includes a bottom 221 on which the insulation member 210 is received and a sidewall 222 extended from an end of the bottom 221 to provide a receiving space.

The light emitting unit 200 further includes first to n-th connection lines 132-1, 132-2, . . . , 132-n formed on the insulation member 210 and an adhesive member 240 interposed between the bottom 221 and the insulation member 210.

Particularly, the first to n-th connection lines 132-1, 132-2, . . . , 132-n connect the first to n-th light source parts 120-1, 120-2, . . . , 120-n and the ground member 220. The adhesive member 240 includes a conductive adhesive material, such as the ACF, and fixes the insulation member 210 to the bottom 221 of the ground member 220.

The insulation member 210 is provided with first to n-th via holes 211-1, 211-2, . . . , 211-n through which the adhesive member 240 is partially exposed. The first to n-th connection lines 132-1, 132-2, . . . , 132-n are connected to the adhesive member 240 through the first to n-th via holes 211-1, 211-2, . . . , 211-n, respectively, thereby connecting the first to n-th light source parts 120-1, 120-2, . . . , 120-n to the ground member 220.

As described above, since the ground member 220 is disposed below the insulation member 210, the insulation member 210 may have a narrower width W2 than a conventional base film on which the ground lines are formed on the insulation member. Further, the ground member 220 may rapidly discharge heat generated from the light emitting unit 200.

The light emitting unit 200 further includes a protective member 170 formed on the insulation member 210 to protect the first to n-th power supply lines 131-1, 131-2, . . . , 131-n and the first to n-th connection lines 132-1, 132-2, . . . , 132-n.

The light emitting unit 200 further includes a connector 250 that is connected to an external device to receive the power supply voltage. The connector 250 is connected to the first to n-th power supply lines 131-2, 131-2, . . . , 131-n to provide the first to n-th power supply lines 131-1, 131-2, . . . , 131-n with the power supply voltage.

As described above, since the light emitting unit 200 includes the ground member 220 having the hard metal material, the connector 250 may be mounted on the insulation member 210 and the light emitting unit 200 may be connected to the external device using the connector 250 and a cable (not shown) connected to the external device. Thus, a separate wire may not be needed to connect the light emitting unit 200 to the external device and it may not be necessary to extend the length of the insulation member 210, which may reduce the manufacturing cost.

The light emitting unit 200 further includes a compensator 180, first to n-th external lines 231-1, 231-2, . . . , 231-n, and first to n-th feedback lines 134-1, 134-2, . . . , 134-n.

The compensator 180 is connected to the first to n-th power supply lines 131-1, 131-2, . . . , 131-n and the first to n-th external lines 231-1, 231-2, . . . , 231-n. The first to n-th external lines 231-1, 231-2, . . . , 231-n are connected to the connector 250 and provide the compensator 180 with the power supply voltage from the connector 250. The first to n-th feedback lines 134-1, 134-2, . . . , 134-n are connected to the first to n-th power supply lines 131-1, 131-2, . . . , 131-n and the first to n-th external lines 231-1, 231-2, . . . , 231-n, respectively, and the currents input to the light source parts 120 are fed back to the compensator 180 through the first to n-th feedback lines 134-1, 134-2, . . . , 134-n.

The compensator 180 controls currents of the first to n-th light source parts 120-1, 120-2, . . . , 120-n using the currents that are fed back from the first to n-th light source parts 120-1, 120-2, . . . , 120-n.

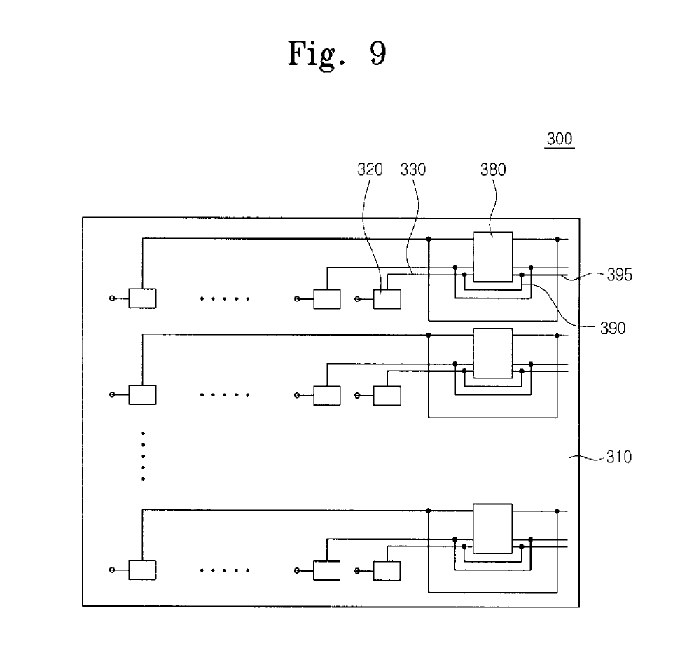

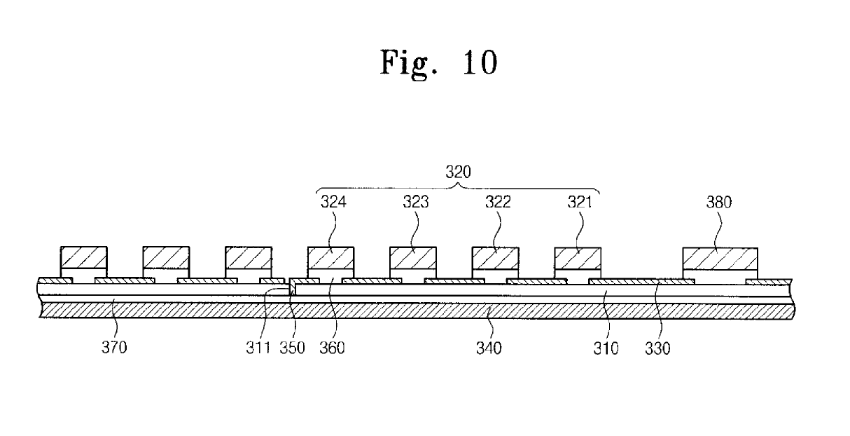

FIG. 9 is a plan view showing a light emitting unit according to another exemplary embodiment of the present invention, and FIG. 10 is a cross-sectional view showing the light emitting unit of FIG. 9.

Referring to FIG. 9 and FIG. 10, a light emitting unit 300 includes an insulation member 310, a plurality of light source parts 320, a plurality of power supply lines 330, and a ground member 340.

The insulation member 310 includes an insulation material, such as polyimide, and is disposed on the ground member 340.

The light source parts 320 and the power supply lines 330 are formed on the insulation member 310. That is, the light source parts 320 are arranged in a matrix configuration and spaced apart from each other.

Each of the light source parts 320 includes first, second, third, and fourth light sources 321, 322, 323, and 324 connected to each other in series. Although four light sources 321, 322, 323, and 324 have been shown in FIG. 10, the number of light sources may increased or decreased as needed.

The light sources 321, 322, 323, and 324 include an approximately point light source, for example a light emitting diode, and are mounted on the insulation member 310 using a conductive member 360. As an example of the present invention, the light sources 321, 322, 323 and 324 may include a light emitting diode that emits white light.

The power supply lines 330 are connected to the light source parts 320, respectively. That is, the power supply lines 330 connected to the light source parts 320 provide the light source parts 320 with the power supply voltage from an exterior device. The power supply lines 330 are connected to first light sources 321 of the light source parts 320, respectively.

The ground member 340 is disposed below the insulation member 310. The ground member 340 is connected to the light source parts 320 to ground the light source parts 320.

The light emitting unit 300 further includes a plurality of connection lines that connect the light source parts 320 and an adhesive member 370, which attaches the insulation member 310 to the ground member 340. The connection lines 350 are formed on the insulation member 310, and the adhesive member 370 is interposed between the insulation member 310 and the ground member 340. The insulation member 310 is provided with via holes 311 through which the adhesive member 370 is partially exposed. The connection lines 350 are connected to the adhesive member 370 through the via holes 311. The adhesive member 370 includes a conductive adhesive member like the ACF, and connects the connection lines 350 and the ground member 340.

As described above, since the light emitting unit 300 includes the ground member 340 disposed below the insulation member 310, the light emitting unit 300 may have a larger space than a conventional light emitting unit having ground lines formed on the insulation member. Thus, more light source parts may be mounted on the insulation member 310, which may enhance the brightness of the light emitting unit 300.

The light emitting unit 300 may further include a plurality of compensators 380 to control the currents of the light source parts 320. In the present exemplary embodiment, the light emitting unit 300 includes multiple compensators 380, but alternatively, the light emitting unit 300 may include only one compensator.

Each compensator 380 is connected to the several light source parts of the light source parts 320 and controls the currents of the connected light source parts thereto. In the present exemplary embodiment, the compensators 380 are positioned adjacent to the light source parts 320 and control the currents of the light source parts 320 arranged in a corresponding row.

The compensators 380 are connected to the power supply lines 330 and also connected to external lines 395 to which the power supply voltage from the exterior is applied. The external lines 395 are connected to the external device (not shown) to receive the power supply voltage.

The feedback lines 390 are connected to the power supply lines 330 and the external lines 395 and provide the external lines 395 with the currents input to the light source parts 320. The compensators 380 receive the currents input to the light source parts 320 through the feedback lines 390 to control the currents and provide the light source parts 320 with the controlled currents through the power supply lines 330.

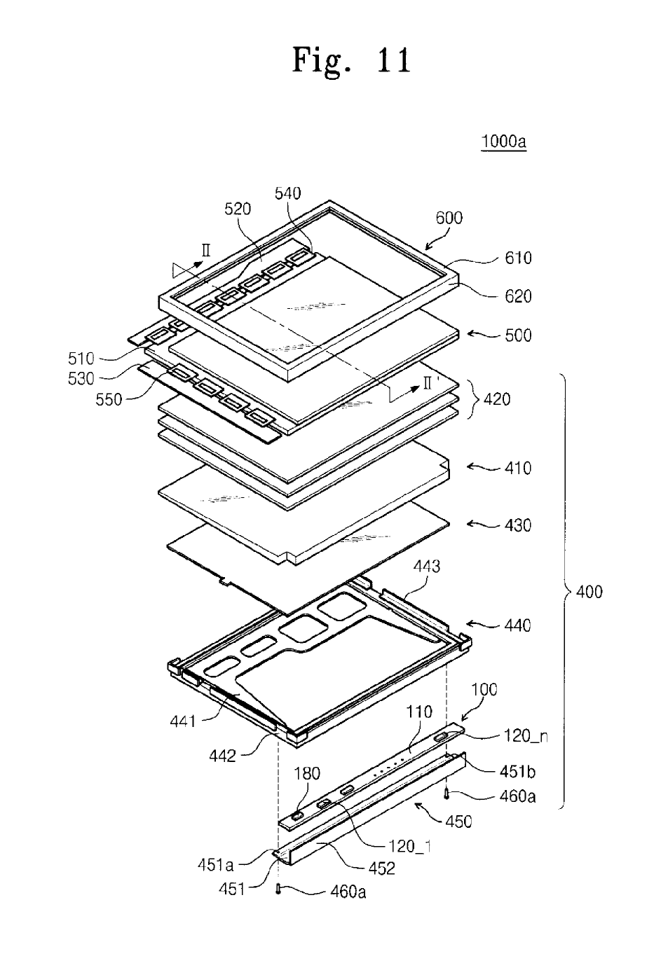

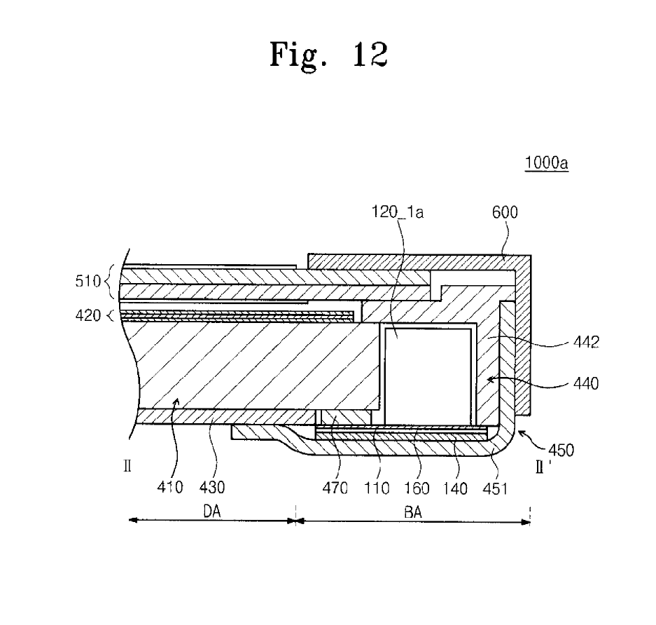

FIG. 11 is an exploded perspective view showing a liquid crystal display according to an exemplary embodiment of the present invention, and FIG. 12 is a cross-sectional view taken along line II-II′ of FIG. 1. In FIG. 11 and FIG. 12, the same reference numerals denote the same elements in FIG. 1, FIG. 2, FIG. 3, FIG. 4, and FIG. 5, and thus, detailed description of the same elements will be omitted.

Referring to FIG. 11 and FIG. 12, a liquid crystal display 1000a includes a backlight assembly 400 and a display panel assembly 500.

The backlight assembly 400 includes a light emitting unit 100, a light guide plate 410, optical sheets 420, a reflection plate 430, and a receiving container 440.

The light emitting unit 100 is positioned adjacent to a side face of the light guide plate 410 and emits the light. The light guide plate 410 changes the path of the light incident from the light emitting unit 100 to output the light as a planar light source. In the present exemplary embodiment, the light guide plate 410 has a wedge shape such that the light guide plate 410 becomes gradually thinner in thickness. The guide plate 410 is thickest at the side corresponding to the light emitting unit 100 and thinnest at the side opposite the light emitting unit 100. However, the light guide plate 410 may be flat. In the case where the light guide plate 410 has a uniform thickness, the backlight assembly 400 includes two light emitting units, and two light emitting units are positioned adjacent to each opposite side face of the light guide plate 410, respectively.

The optical sheets 420 are disposed on the light guide plate 410 and improve the optical properties, such as the brightness enhancement and the brightness uniformity, of the light from the light guide plate 410. In order to enhance the brightness and to improve the brightness uniformity, the optical sheets 420 may include a prism sheet condensing the light and a diffusion sheet diffusing the light. The reflection plate 430 is disposed under the light guide plate 410 to reflect the light leaked from the light guide plate 410.

The receiving container 440 receives the light emitting unit 100, the light guide plate 410, the optical sheets 420, and the reflection plate 430. The receiving container 440 includes a bottom 441 and a sidewall 442 extended from an end of the bottom 441 to provide a receiving space. The reflection plate 430, the light guide plate 410, and the optical sheets 420 are sequentially received onto the bottom 441, and the display panel assembly 500 is disposed onto the sidewall 442. The receiving container 440 further includes a guide portion 443 that guides the position of the display panel assembly 500. The guide portion 443 is upwardly extended from an upper portion of the sidewall 442.

The first to n-th light source parts 120-1, . . . , 120-n of the light emitting unit 100 are positioned between the sidewall 442 of the receiving container 440 and the light guide plate 410, and a portion of the base film 110 of the light emitting unit 100 is disposed under the light guide plate 410. A fixing member 470 may be installed between the light guide plate 410 and the base film 110 to attach the base film 110 to the lower surface of the light guide plate 410.

The light emitting unit 100 includes the ground member 140 disposed under the base film 110, which may minimize the width W1 (see FIG. 2) of the light emitting unit 100 and reduce the size of the liquid crystal display 1000a.

In other words, the liquid crystal display 1000a includes a display area DA on which the image is displayed and a bezel area BA surrounding the display area DA on which no image is displayed. Since the light emitting unit 100 is positioned in the bezel area BA, the width of the bezel area BA may be reduced according to the reduction of the width W1 of the light emitting unit 100. Thus, it may be possible to reduce the bezel area BA of the liquid crystal display 1000a without reducing the size of the display area DA.

The backlight assembly 400 further includes a back cover 450 that is positioned outside the receiving container 440. The back cover 450 includes a first portion 451 on which the light emitting unit 100 is received and a second portion 452 extended from the first portion 451 to partially cover the sidewall 442 of the receiving container 440. The back cover 450 includes a metal material, and the first portion 451 makes contact with the ground member 140 of the light emitting unit 100, thereby rapidly discharging the heat generated from the light emitting unit 100.

Also, the back cover 450 is provided with engaging holes 451a and 451b formed through the first portion 451. The back cover 450 is coupled with the receiving container 440 by means of screws 460a and 460b that are engaged with the receiving container 440 after passing through the engaging holes 451a and 451b, respectively.

The display panel assembly 500 is disposed on the backlight assembly 400. The display panel assembly 500 includes a liquid crystal display panel 510 displaying the image thereon, a data printed circuit board 520 applying a data driving signal to the liquid crystal display panel 510, a gate printed circuit board 530 applying a gate driving signal to the liquid crystal display panel 510, a data tape carrier package 540 connecting the data printed circuit board 520 and the liquid crystal display panel 510, and a gate tape carrier package 550 connecting the gate printed circuit board 530 and the liquid crystal display panel 510.

The liquid crystal display 1000a further includes a top chassis 600 to fix the liquid crystal display panel 510 to the receiving container 440. The top chassis 600 guides the position of the liquid crystal display panel 510 and is coupled with the receiving container 440, thereby fixing the liquid crystal display panel 510 to the receiving container 440.

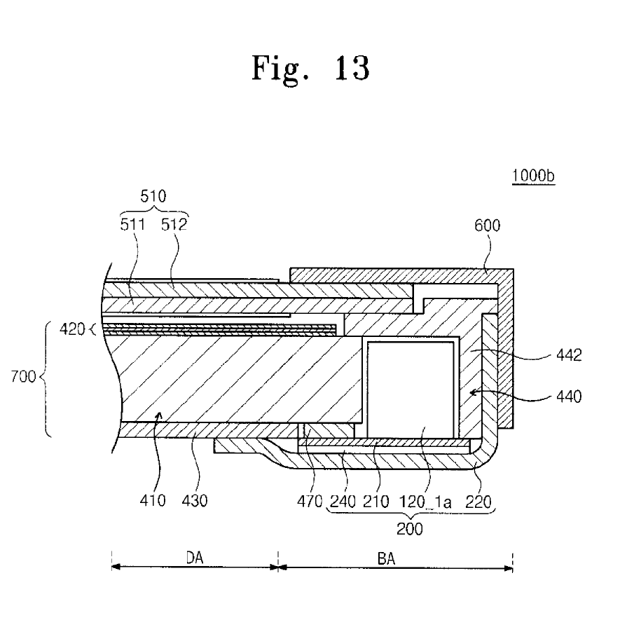

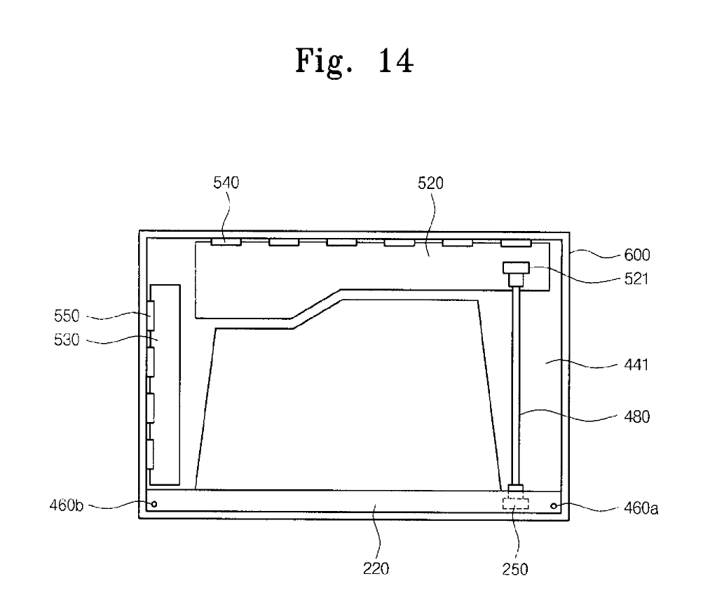

FIG. 13 is a cross-sectional view showing a liquid crystal display according to another exemplary embodiment of the present invention, and FIG. 14 is a plan view showing the lower face of the liquid crystal display of FIG. 13. In FIG. 13 and FIG. 14, a liquid crystal display 1000b has the same configuration as that of the liquid crystal display 1000a in FIG. 11 and FIG. 12 except for the light emitting unit and the back cover. Thus, the same elements are referenced with the same reference numerals and detailed descriptions of the same elements will be omitted.

Referring to FIG. 13 and FIG. 14, the liquid crystal display 1000b includes a backlight assembly 700 and a display panel assembly 500.

The backlight assembly 700 includes a light emitting unit 200, a light guide plate 410, optical sheets 420, a reflection plate 430, and a receiving container 440.

In the present exemplary embodiment, the light emitting unit 200 has same configuration as that of the light emitting unit in FIG. 6, FIG. 7, and FIG. 8, so that the same elements are referenced with the same reference numerals and detailed descriptions of the same elements will be omitted.

Referring to FIG. 6 and FIG. 13, the first to n-th light source parts 120-1, 120-2, . . . , 120-n of the light emitting unit 200 are positioned between the light guide plate 410 and the sidewall 442 of the receiving container 440. The insulation member 210 of the light emitting unit 200 is partially disposed under the light guide plate 410. The ground member 220 of the light emitting unit 200 covers the outside of the receiving container 440. That is, the bottom 221 of the ground member 220 supports an end of the reflection plate 430, and the sidewall 222 of the ground member 220 partially covers the sidewall 442 of the receiving container 440.

Referring to FIG. 7 and FIG. 14, the connector 250 of the light emitting unit 200 is connected to the data printed circuit board 520 of the display panel assembly 500 through the cable 480.

In other words, the data printed circuit board 520 includes a sub-connector 521 connected to the cable 480. The cable 480 includes first and second insertion portions formed at both ends thereof, and the first and second insertion portions are inserted into the connector 250 of the light emitting unit 200 and the sub-connector 521 of the data printed circuit board 520, respectively. Accordingly, the light emitting unit 200 may be connected to the data printed circuit board 520 through the cable 480. The light emitting unit 200 receives various signals, such as the power supply voltage for the first to n-th light source parts 120-1, 120-2, . . . , 120-n, the control signal, etc., from the data printed circuit board 520 through the cable 480.

As described above, since the ground member 220 of the light emitting unit 200 includes the hard metal material, the connector 250 may be mounted on the ground member 220. Thus, the light emitting unit 200 may be connected to the data printed circuit board 520 using the connector 250 and the cable 480, which may reduce the manufacturing cost. Further, since the cable 480 may have various lengths, the cable 480 may connect the data printed circuit board 520 and the light emitting unit 200 without relating to the distance between the data printed circuit board 520 and the light emitting unit 200. Therefore, the light emitting unit 200 may be connected to the data printed circuit board 520 in a large-sized liquid crystal display.

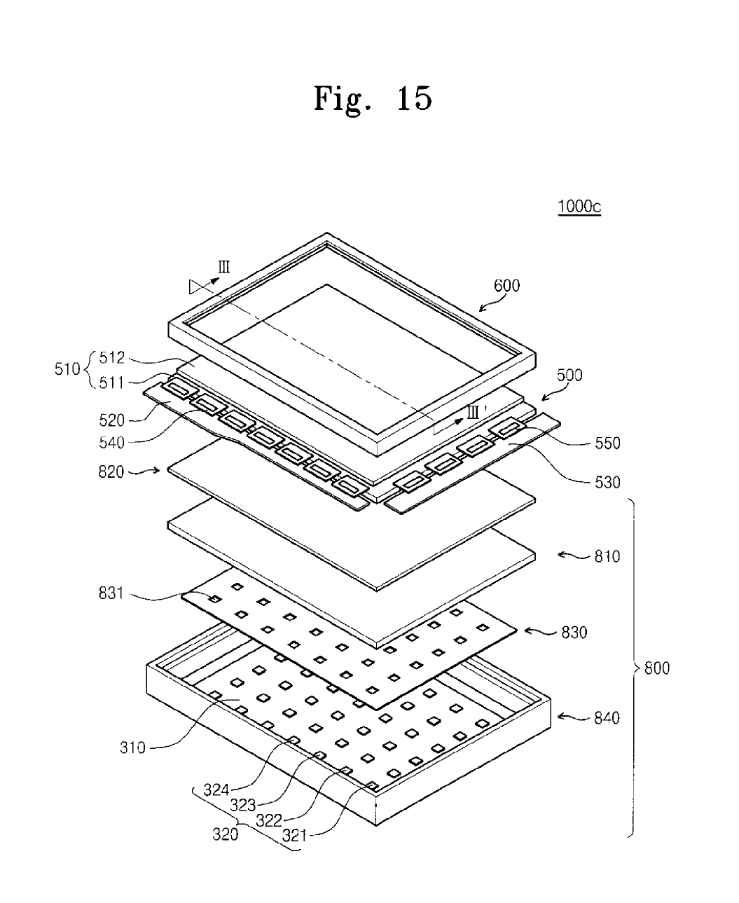

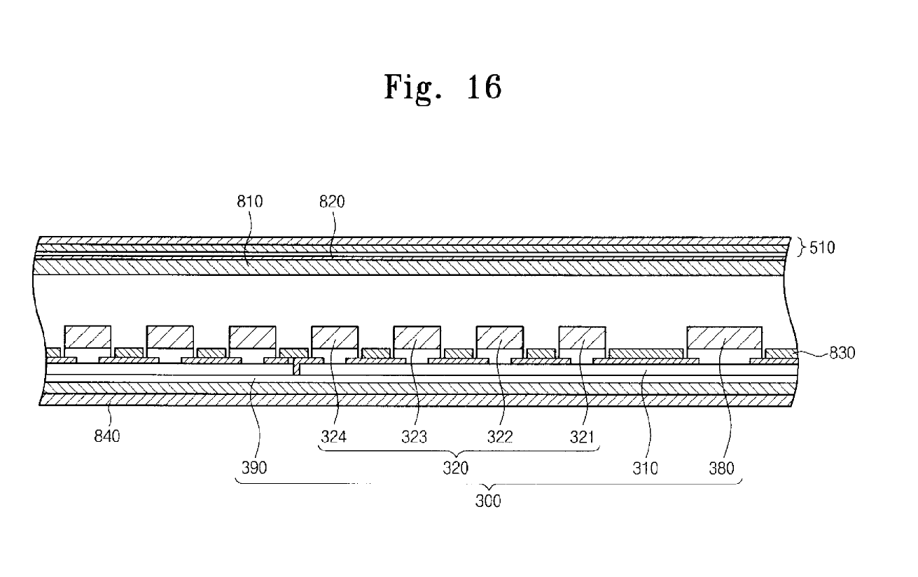

FIG. 15 is an exploded perspective view showing another exemplary embodiment of a liquid crystal display according to the present invention, and FIG. 16 is a cross-sectional view taken along line III-III′ of FIG. 15.

Referring to FIG. 15 and FIG. 16, a liquid crystal display 1000c includes a backlight assembly 800, a display panel assembly 500, and a top chassis 600.

The backlight assembly 800 includes a light emitting unit 300, a diffusion plate 810, a diffusion sheet 820, a reflection plate 830, and a receiving container 840.

In FIG. 15 and FIG. 16, the light emitting unit 300 has same configuration as that of the light emitting unit in FIG. 9 and FIG. 10, and thus the same elements are referenced with the same reference numerals and detailed descriptions of the same elements will be omitted.

The light emitting unit 300 includes the insulation member 310 on which the light source parts 320 are mounted, and the insulation member 310 is disposed on the ground member 340. Thus, the light emitting unit 300 may have a larger space than a conventional light emitting unit having ground lines for the light source parts formed on the insulation member 310. As a result, more light source parts may be mounted on the insulation member 310, which may enhance the brightness of the liquid crystal display 1000c and improve display quality of the liquid crystal display 1000c.

The diffusion plate 810 and the diffusion sheet 820 are sequentially disposed on the light emitting unit 300 to diffuse the light emitted from the light emitting unit 300. In the present exemplary embodiment, the diffusion plate 810 is spaced apart from the light source parts 320 of the light emitting unit 300 in order to obtain a space for the mixture of the light from the light emitting unit 300.

The reflection plate 830 is disposed on the insulation member 310 of the light emitting unit 300 to reflect the light incident from the light emitting unit 300. The reflection plate 830 is provided with a plurality of holes 831 formed therethrough, and one of the first to n-th light sources 321, 322, 323 and 324 is inserted into each hole 831.

The receiving container 840 receives the light emitting unit 300, the diffusion plate 810, the diffusion sheet 820, and the reflection plate 830.

The display panel assembly 500 is disposed on the backlight assembly 800. The display panel assembly 500 is received into the receiving container 840 and displays the image using the light provided from the backlight assembly 800.

According to the above, the light emitting unit includes the ground member disposed under the insulation member on which the light source parts are mounted. Thus, the insulation member may not need additional ground lines to ground the light source parts, thereby reducing the width of the light emitting unit and the bezel area of the liquid crystal display. Thus, the liquid crystal display may have a reduced size.

Also, since the ground member of the light emitting unit has a substantially plate-like shape, the heat generated from the light source parts may be rapidly discharged. The inner temperature of the liquid crystal display may be uniformly maintained.

Further, the light emitting unit may include additional light source parts positioned in an area in which the ground lines are removed, to thereby enhance the brightness of the light emitting unit and improve the display characteristics of the liquid crystal display.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A light emitting unit, comprising:
an insulation member;
at least one light source part disposed on the insulation member to receive a power supply voltage and generate a light;
at least one power supply line disposed on the insulation member and connected to the light source part to provide the power supply voltage to the light source part; and
a ground member disposed below the insulation member and connected to the light source part to ground the light source part.

2. The light emitting unit of claim 1, further comprising a connection line connecting the light source part and the ground member.

3. The light emitting unit of claim 2, wherein the insulation member comprises a via hole and the connection line is connected to the ground member through the via hole.

4. The light emitting unit of claim 1, wherein the light source part comprises a plurality of light sources connected to each other in series, and the power supply line is connected to one of the light sources.

5. The light emitting unit of claim 4, wherein the ground member is connected to one of the light sources.

6. The light emitting unit of claim 4, wherein the light sources comprise light emitting diodes.

7. The light emitting unit of claim 1, further comprising a compensator connected to the power supply line to receive a current input to the light source part to control the current for the light source part.

8. The light emitting unit of claim 1, wherein there are a plurality of light source parts and a plurality of power supply lines, each power supply line is connected to a corresponding light source part, and each light source part is disposed on the insulation member and connected to the ground member.

9. The light emitting unit of claim 8, further comprising
an adhesive member interposed between the insulation member and the ground member to attach the insulation member to the ground member; and
a connector disposed on the insulation member and connected between an external device and the power supply line to transmit a control signal to the power supply line from the external device to control the light source part.

10. A backlight assembly, comprising:
a light guide plate to guide a light; and
a light emitting unit comprising:
an insulation member;
at least one light source part to receive a power supply voltage and generate a light, the light source part being disposed on the insulation member and positioned adjacent to a side face of the light guide plate;
at least one power supply line to provide the power supply voltage to the light source part, the power supply line being disposed on the insulation member and electrically connected to the light source part; and
a ground member to ground the light source part, the ground member being disposed below the insulation member and connected to the light source part.

11. The backlight assembly of claim 10, wherein the insulation member comprises a via hole and the light emitting unit further comprises a connection line connecting the light source part and the ground member through the via hole.

12. The backlight assembly of claim 10, wherein the light emitting unit further comprises a compensator connected to the power supply line to receive a current input to the light source part to control the current for the light source part.

13. The backlight assembly of claim 10, wherein the light emitting unit further comprises a connector disposed on the insulation member and connected between an external device and the power supply line to transmit a control signal to the power supply line from the external device to control the light source part, and wherein the ground member comprises a bottom on which the insulation member is disposed and a sidewall extended from the bottom to provide a receiving space in which the light guide plate is received.

14. The backlight assembly of claim 10, further comprising a cover member comprising a metal material, the cover member being disposed under the ground member to cover the ground member.

15. A backlight assembly, comprising:
a light emitting unit to emit a light; and
an optical sheet disposed on the light emitting unit to enhance optical properties of the light,
the light emitting unit comprising:
an insulation member;
at least one light source part to receive a power supply voltage and generate a light, the light source part being disposed on the insulation member;
at least one power supply line to provide the power supply voltage to the light source part, the power supply line being disposed on the insulation member and connected to the light source part; and
a ground member to ground the light source part, the ground member being disposed below the insulation member and connected to the light source part.

16. The backlight assembly of claim 15, wherein the insulation member comprises a via hole and the light emitting unit further comprises a connection line connecting the light source part and the ground member through the via hole.

17. The backlight assembly of claim 15, wherein the light emitting unit further comprises a compensator connected to the power supply line to receive a current input to the light source part to control the current for the light source part.

18. The backlight assembly of claim 15, wherein the light emitting unit further comprises a connector disposed on the insulation member and connected between an external device and the power supply line to transmit a control signal to the power supply voltage line from the external device to control the light source part.

19. The backlight assembly of claim 15, further comprising a cover member comprising a metal material, the cover member being disposed under the ground member to cover the ground member.

20. The backlight assembly of claim 15, wherein the light source part comprises a plurality of light emitting diodes.

21. The backlight assembly of claim 20, further comprising a reflection member disposed on the insulation member to reflect light from the light source part, the reflection member comprising a via hole into which the light source part is inserted.

22. A display apparatus, comprising:
a display panel assembly comprising a display panel that displays an image corresponding to an image signal using a light, and a driving circuit part that applies the image signal to the display panel; and
a light emitting unit disposed under the display panel to supply the light to the display panel,
the light emitting unit comprising:
an insulation member;
at least one light source part to receive a power supply voltage and generate the light, the light source part being disposed on the insulation member;
at least one power supply line to provide the power supply voltage to the light source part, the power supply line being disposed on the insulation member and connected to the light source part; and
a ground member to ground the light source part, the ground member being disposed below the insulation member and connected to the light source part.

23. The display apparatus of claim 22, wherein the light emitting unit further comprises a connector disposed on the insulation member and connected between the driving circuit part and the power supply line to transmit a control signal to the power supply line from the driving circuit part to control the light source part.

24. The display apparatus of claim 23, further comprising a cable connected between the driving circuit part and the connector to transmit the control signal output from the driving circuit part to the connector.

25. The display apparatus of claim 22, wherein the insulation member is comprises a via hole and the light emitting unit further comprises a connection line connecting the light source part and the ground member through the via hole.

26. The display apparatus of claim 22, wherein the light emitting unit further comprises a compensator connected to the power supply line to receive a current input to the light source part to control the current for the light source part.

27. The display apparatus of claim 22, further comprising a cover member comprising a metal material, the cover member being disposed under the ground member to cover the ground member.
